(19) United States
(12) Patent Application Publication
(10) Pub. No.: US 2023/0099878 A1
(43) Pub. Date: Mar. 30, 2023

(54) TENSION ADJUSTER, MEDIUM CONVEYOR, AND IMAGE FORMING APPARATUS

(71) Applicant: Ryo Honda, Kanagawa (JP)

(72) Inventor: Ryo Honda, Kanagawa (JP)

(73) Assignee: Ricoh Company, Ltd., Tokyo (JP)

(21) Appl. No.: 17/944,436

(22) Filed: Sep. 14, 2022

(30) Foreign Application Priority Data
Sep. 27, 2021 (JP) 2021-157122

(51) Int. Cl. B41J 15/16

(52) U.S. Cl. CPC B41J 15/165

(57) ABSTRACT

A tension adjuster includes a plurality of drive shafts, a plurality of drive sources to rotate the plurality of drive shafts, and a drive transmitter to transmit rotational drive force of the plurality of drive shafts to a rotary shaft of a conveyance object wound in a roll. The drive transmitter includes a planetary gear mechanism including a sun gear rotated by a first drive shaft of the plurality of drive shafts and a planetary gear carrier rotated by a second drive shaft of the plurality of drive shafts. The planetary gear mechanism attenuates rotational drive force of one of the plurality of drive shafts to transmit the rotational drive force of the first drive shaft to the rotary shaft of the conveyance object, based on a damping ratio defined by a number of rotations of the sun gear and a number of rotations of the planet gear carrier.

### CROSS-REFERENCE TO RELATED APPLICATION

This patent application is based on and claims priority pursuant to 35 U.S.C. § 119(a) to Japanese Patent Application No. 2021-157122, filed on Sep. 27, 2021, in the Japan Patent Office, the entire disclosure of which is hereby incorporated by reference herein.

### BACKGROUND

### Technical Field

Embodiments of the present disclosure relate to a tension adjuster, a medium conveyor, and an image forming apparatus.

### Background Art

Various types of tension adjusters in the related art include a roll holding mechanism that conveyably holds a roll medium serving as a target medium including a continuous sheet medium (“medium”) wound in a roll. The roll holding mechanism holds the roll medium so that the medium can be conveyed out of the roll medium. Such tension adjusters in the related art are known to adjust the tension to be applied to the roll medium. Further, various types of devices and apparatuses in the related art are known to include a tension adjuster. Such devices and apparatuses may be a medium conveyor that conveys a roll medium while applying tension to the roll medium, a liquid discharge device that discharges liquid to the roll medium being conveyed while receiving the tension, and an image forming apparatus that forms an image on a medium with liquid discharged to the medium.

In order to apply a constant tension to the roll medium, such a tension adjuster is required to adjust the drive torque in accordance with the outer diameter of the roll medium held by a roll holding device disposed facing face the roll holding mechanism.

A technique is known for varying drive torque in accordance with the outer diameter of a roll medium by varying a reduction ratio with a friction drive transmission mechanism.

### SUMMARY

Embodiments of the present disclosure described herein provide a novel tension adjuster including a plurality of drive shafts, a plurality of drive sources configured to rotate the plurality of drive shafts, and a drive transmitter to transmit rotational drive force of the plurality of drive shafts to a rotary shaft of a conveyance object wound in a roll. The drive transmitter includes a planetary gear mechanism including a sun gear that is rotated by and coupled to a first drive shaft of the plurality of drive shafts and a planetary gear carrier that is rotated by and coupled to a second drive shaft of the plurality of drive shafts. The planetary gear mechanism attenuates rotational drive force of one of the plurality of drive shafts to transmit the rotational drive force to the rotary shaft of the conveyance object. The planetary gear mechanism transmits rotational drive force of the first drive shaft to the rotary shaft of the conveyance object, based on a damping ratio defined by a number of rotations of the sun gear and a number of rotations of the planet gear carrier.

Further, embodiments of the present disclosure described herein provide a medium conveyor including a medium feeder and a medium winder. The medium feeder feeds the conveyance object as a medium at a position upstream from a conveyor that conveys the conveyance object in a conveyance direction of the conveyance object. The medium winder winds the conveyance object as a medium at a position downstream from the conveyor in the conveyance direction of the conveyance object. At least one of the medium feeder or the medium winder includes the above-described tension adjuster.

Further, embodiments of the present disclosure described herein provide an image forming apparatus including a recording head to form an image on a conveyance object with liquid discharged onto the conveyance object, and the above-described tension adjuster.

### BRIEF DESCRIPTION OF THE SEVERAL VIEWS OF THE DRAWINGS

Exemplary embodiments of this disclosure will be described in detail based on the following figures, wherein:

FIG. 1 is a partially transparent perspective view of an image forming apparatus according to an embodiment of the present disclosure;

FIG. 2 is a schematic side view of the image forming apparatus of FIG. 1;

FIG. 3 is a partially transparent plan view of a liquid discharge device included in the image forming apparatus of FIG. 1;

FIG. 4 is a side view of a roll holding device serving as a medium conveyor included in the image forming apparatus of FIG. 1;

FIG. 5 is a rear view of the roll holding device of FIG. 4;

FIG. 6 is a longitudinal sectional view of a tension adjuster included in the roll holding device of FIG. 4; and

FIG. 7 is an axial projection view of a planetary gear mechanism included in the tension adjuster of FIG. 6.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers referred to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Referring now to the drawings, embodiments of the present disclosure are described below. In the drawings for explaining the following embodiments, the same reference codes are allocated to elements (members or components) having the same function or shape and redundant descriptions thereof are omitted below.

Hereinafter, embodiments of the present disclosure are described with reference to the drawings.

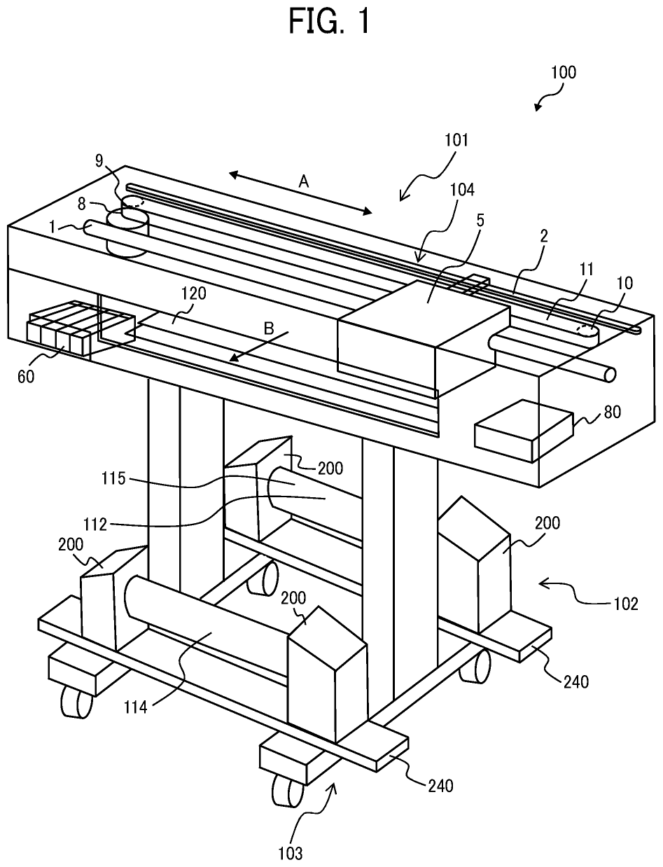

Descriptions are given of an inkjet printer 100 serving as an image forming apparatus provided with a media conveyor, according to the present disclosure, with reference to FIGS. 1 to 3.

FIG. 1 is a partially transparent perspective view of the inkjet printer 100, viewed from the outside of the inkjet printer 100.

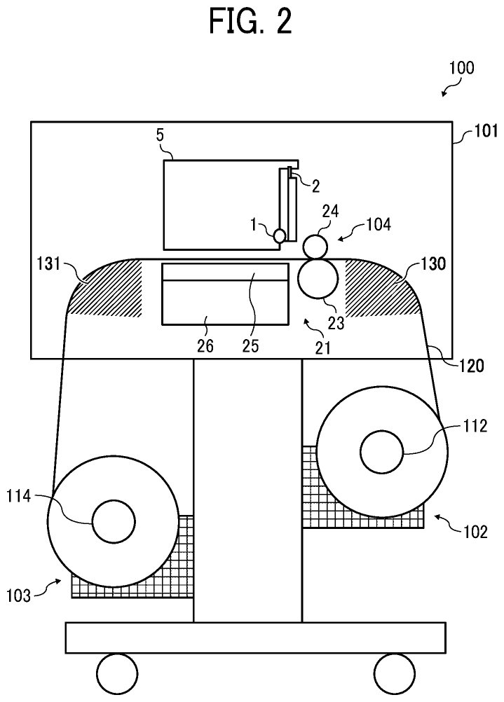

FIG. 2 is a schematic side view of the inkjet printer 100.

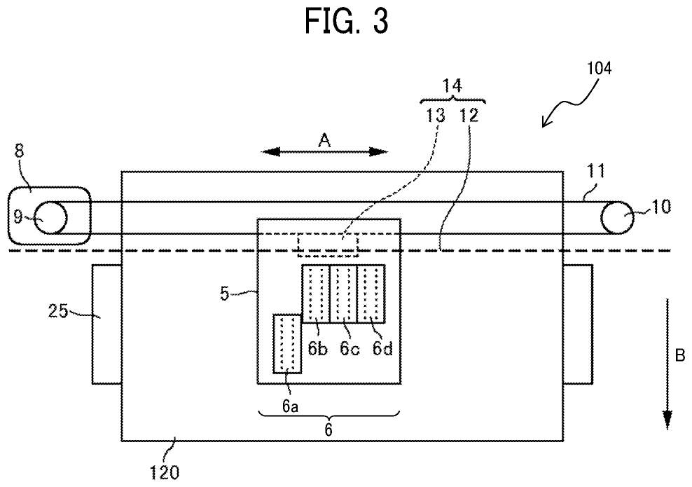

FIG. 3 is a partially transparent plan view of the image forming device 104 as a liquid discharge device included in the inkjet printer 100. The plan view of FIG. 3 illustrates the main part of the image forming device 104.

As illustrated in FIG. 1, the inkjet printer 100 is a serial-type image forming apparatus. The inkjet printer 100 includes a housing 101, a sheet feeding device 102 disposed below the housing 101, and a sheet winding device 103 disposed below the housing 101 at the position facing the sheet feeding device 102.

The sheet feeding device 102 may be disposed below the housing 101 as a unit separate from the housing 101 or may be disposed in the housing 101 as a single unit with the housing 101 as illustrated in FIG. 2. Like the sheet feeding device 102, the sheet winding device 103 may be disposed below the housing 101 as a unit separate from the housing 101 or may be disposed in the housing 101 as a single unit with the housing 101 as illustrated in FIG. 2.

Each of the sheet feeding device 102 and the sheet winding device 103 serves as a media conveyor according to an embodiment of the present disclosure. For this reason, each of the sheet feeding device 102 and the sheet winding device 103 includes a tension adjuster according to the present disclosure.

The sheet feeding device 102, the sheet winding device 103, and the image forming device 104 are included inside the housing 101 illustrated in FIG. 2. The sheet feeding device 102 serves as a medium feeder to feed and supply a sheet 120 from a rolled sheet 112 to the image forming device 104. The rolled sheet 112 is formed by winding the sheet 120 (continuous sheet medium) in a roll. The sheet winding device 103 serves as a medium winder to wind the sheet 120 of the rolled sheet 112 while the image is formed on the sheet 120. The image forming device 104 forms an image on the sheet 120 of the rolled sheet 112.

The image forming device 104 includes a guide rod 1 and a guide stay 2, each serving as a guide. The guide rod 1 and the guide stay 2 are disposed between side plates disposed on both sides of the image forming device 104. A carriage 5 is supported by the guide rod 1 and the guide stay 2 to be movable in a direction that the carriage 5 moves, in other words, the main scanning direction indicated by arrow A in FIG. 3.

As illustrated in FIG. 3, the image forming device 104 includes a main scanning motor 8 serving as a drive source. The main scanning motor 8 is disposed on one side of the image forming device 104 along the main scanning direction to reciprocate the carriage 5. The main scanning motor 8 rotates a drive pulley 9. A timing belt 11 is wound around the drive pulley 9 and a driven pulley 10 that is disposed on the opposite side of the image forming device 104 along the main scanning direction. A belt holding portion of the carriage is fixed to the timing belt 11. As the main scanning motor 8 drives, the carriage 5 moves reciprocally in the main scanning direction.

Multiple recording heads 6a, 6b, 6c, and 6d (see FIG. 3) are equipped with the carriage 5. Each of the recording heads 6a, 6b, 6c, and 6d integrally includes a liquid discharge head and a head tank. The liquid discharge head of each of the recording heads 6a, 6b, 6c, and 6d discharges liquid to a medium (e.g., the sheet 120) to form an image on the medium with the liquid discharged onto the medium. The head tank supplies the liquid to the liquid discharge head. In the following description, when the multiple recording heads 6a, 6b, 6c, and 6d are not separately distinguished, the respective recording heads 6a, 6b, 6c, and 6d are referred to as the “recording head 6” in a singular form or collectively referred to as the “recording heads 6”.

The recording head 6a is disposed one head (corresponding to the length of a nozzle array) away from the recording heads 6b, 6c, and 6d in the sub-scanning direction indicated by arrow B in FIG. 3. The sub-scanning direction is perpendicular to the main scanning direction indicated by arrow A.

The recording head 6 includes a nozzle array including a plurality of nozzles from each of which liquid is discharged. The plurality of nozzles is arranged in the sub-scanning direction perpendicular to the main scanning direction. The recording head 6 discharges liquid downward from the nozzles.

Each of the recording heads 6a, 6b, 6c, and 6d has two nozzle rows. Each of the recording heads 6a and 6b discharges droplets of black (K) from the two nozzle rows. In other words, the droplets of the same color are discharged from the two nozzle rows. The recording head 6c discharges droplets of cyan (C) from one nozzle row, and the other nozzle row remains unused. The recording head 6d discharges droplets of magenta (M) from one nozzle row and discharges droplets of yellow (Y) from the other nozzle row.

As a result, the inkjet printer 100 can form a monochrome image corresponding to the width of two recording heads 6 by one scan in the main scanning direction with the recording heads 6a and 6b. Further, the inkjet printer 100 can form a color image with, for example, the recording heads 6b, 6c, and 6d. The configuration of the recording heads 6 is not limited to the configuration as described above. For example, a plurality of recording heads may all be arranged in the main scanning direction.

The image forming device 104 further includes an encoder sheet 12 and an encoder sensor 13. The encoder sheet 12 is disposed in the direction of movement of the carriage 5. The encoder sensor 13 to read the encoder sheet 12 is mounted on the carriage 5. The encoder sheet 12 and the encoder sensor 13 are included in a linear encoder 14. The position and speed of the carriage 5 are detected based on the output of the linear encoder 14.

The inkjet printer 100 further includes a sheet conveying device 21 as illustrated in FIG. 2. The sheet conveying device 21 conveys the sheet 120 of the rolled sheet 112 from the sheet feeding device 102 to a recording area of a main scanning region of the carriage 5. The sheet 120 is intermittently conveyed in the direction of conveyance of the sheet 120, which is the same as the sub-scanning direction indicate by arrow B in FIG. 3 and perpendicular to the main scanning direction of the carriage 5. As illustrated in FIG. 1, ink of each color is supplied to the head tank of a corresponding recording head 6 via a supply tube from an ink cartridge 60 that is a main tank replaceably installed in the housing 101. The inkjet printer 100 further includes a maintenance and recovery device 80 as illustrated in FIG. 1. The maintenance and recovery device 80 maintains and recovers the performance of the recording heads 6 that are disposed next to a conveyance guide 25 on one side in the main scanning direction of the carriage 5.

As illustrated in FIG. 2, the sheet conveying device 21 includes a conveyance roller 23 to convey the sheet 120 of the rolled sheet 112 from the sheet feeding device 102 and a pressure roller 24 disposed facing the conveyance roller 23. Each of the conveyance roller 23 and the pressure roller 24 serves as a conveyor. The sheet conveying device 21 further includes a conveyance guide 25 and a suction fan 26. The conveyance guide 25 has multiple suction holes. The suction fan 26 serves as a suction device to suck air through the multiple suction holes of the conveyance guide 25. The conveyance guide 25 and the suction fan 26 are disposed downstream from the conveyance roller 23 in the conveyance direction of the sheet 120.

The inkjet printer 100 includes a cutter disposed downstream from the sheet conveying device 21 in the conveyance direction of the sheet 120. The cutter cuts the sheet 120 of the rolled sheet 112, on which an image has been printed by the recording heads 6, at a predetermined length.

The rolled sheet 112 as a roll medium loaded in the sheet feeding device 102 is obtained by winding the sheet 120, which corresponds to the continuous sheet medium, around a hollow shaft 114 such as a paper tube serving as a core material. In the rolled sheet 112 according to the present embodiment, the end of the sheet 120 may be fixed to the hollow shaft 114 by adhesion such as gluing or may not be fixed to the hollow shaft 114. Such a rolled sheet 112 can be loaded in the sheet feeding device 102.

As illustrated in FIG. 2, the inkjet printer 100 further includes a guide 130 and a sheet ejection guide 131 in the housing 101 as illustrated in FIG. 2. The guide 130 guides the sheet 120 of the rolled sheet 112 that is fed from the sheet feeding device 102. After the sheet 120 of the rolled sheet 112 is sucked, the sheet ejection guide 131 guides the sheet 120 of the rolled sheet 112 at a position downstream from the guide 130 and the conveyance guide 25 in the conveyance direction of the sheet 120.

The sheet winding device 103 includes a hollow shaft 115 such as a paper tube serving as the core material. The leading end of the sheet 120 pulled out of the rolled sheet 112 is adhered to the hollow shaft 115 with, for example, a tape.

With the above-described configuration, the inkjet printer 100 reciprocally moves the carriage 5 in the main scanning direction and causes the sheet conveying device 21 to intermittently convey the sheet 120 of the rolled sheet 112 from the sheet feeding device 102 during image formation. Then, the inkjet printer 100 drives the recording heads 6 in accordance with image data (print data) to discharge droplets, thereby forming a desired image on the sheet 120 of the rolled sheet 112. The sheet 120 of the rolled sheet 112 having the image is guided by the sheet ejection guide 131 to be wound around the hollow shaft 115 provided in the sheet winding device 103. The sheet 120 of the rolled sheet 112 is conveyed on the conveyance roller 23 while tension is applied from each of the sheet feeding device 102 and the sheet winding device 103. Each tension affects the conveyance accuracy.

Embodiment of Medium Conveyor

A description is given of a roll holding device 200 as an embodiment of a medium conveyor according to the present disclosure.

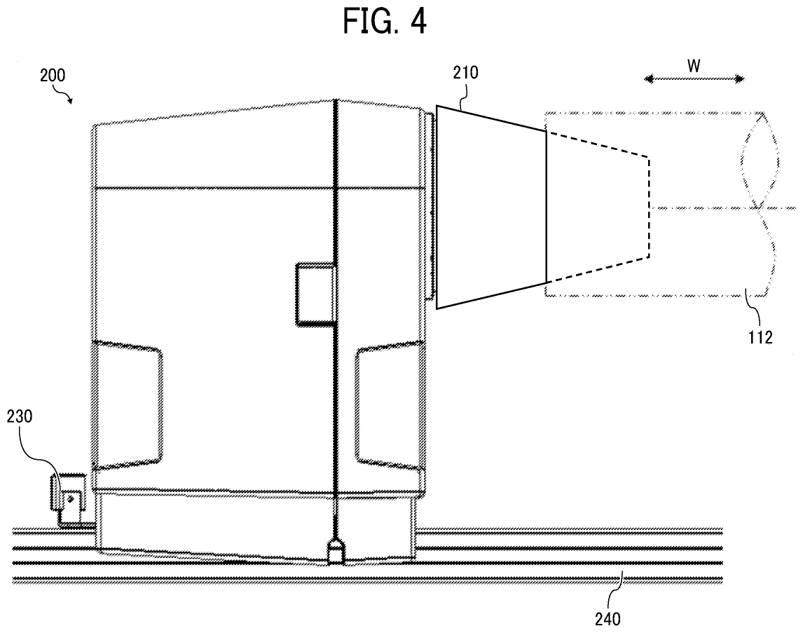

FIG. 4 is a schematic side view of the roll holding device 200 in its entirety.

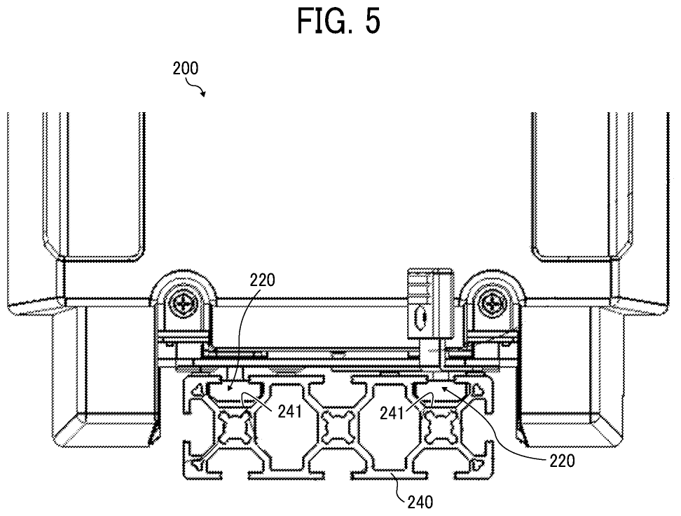

FIG. 5 is a rear view of the roll holding device 200.

As illustrated in FIG. 1, a plurality of roll holding devices 200 hold both ends of the rolled sheet 112. In FIG. 1, the roll holding devices 200 are disposed in pairs. As a result, the roll holding devices 200 are disposed facing each other as a pair.

The roll holding devices 200 in pair disposed facing each other have the like configuration. For this reason, the following description is given of the configuration and functions of one of the roll holding devices 200. The roll holding devices 200 in pair having the like configuration are disposed at both ends of the rolled sheet 112 so as to hold the rolled sheet 112 at both ends. Due to such a configuration, the sheet 120 of the rolled sheet 112 is conveyed while the rolled sheet 112 is held by the roll holding devices 200 in the inkjet printer 100 as described above.

As illustrated in FIGS. 4 and 5, the roll holding device 200 has a substantially square poll type box in appearance and is provided with a roll core holding mechanism 210 at a portion facing the rolled sheet 112, on one side face of the roll holding device 200. The roll holding device 200 further includes a plurality of sliders 220 (“sliders 220”) and a lock lever 230. A guide rail 240 serving as a guide holds the roll holding device 200 via the sliders 220, so that the roll holding device 200 is slidable on the guide rail 240 in one direction only. As illustrated in FIG. 1, the guide rail 240 serves as a part of the sheet feeding device 102 and the sheet winding device 103, and movably holds the roll holding devices 200 in the direction parallel to the direction indicated by arrow A in FIG. 1.

The roll core holding mechanism 210 is fitted into the hollow shaft (e.g., the hollow shaft 114 or 115) of the rolled sheet 112 and holds the rolled sheet 112 at a given position. The detailed description of the roll core holding mechanism 210 is given below.

Each of the sliders 220 is a movement guide that allows the roll core holding mechanism 210 to move in the width direction W of the rolled sheet 112 and restricts the roll core holding mechanism 210 from moving in the direction perpendicular to the width direction W. As illustrated in FIG. 5, the guide rail 240 includes a guide groove 241. The guide groove 241 of the guide rail 240 causes each of the sliders 220 to allow or restrict movement of the rolled sheet 112 in the width direction W. The sliders 220 are disposed on the bottom face of the housing of the roll holding device 200.

While the guide rail 240 movably holds the roll holding device 200 in the width direction W with the sliders 220, the lock lever 230 serves as a movement restrictor that restricts the roll holding device 200 held by the guide rail 240 from moving in the width direction W. When the lock lever 230 is operated, the sliders 220 that are not pressed against the inner wall of the guide groove 241 change to be pressed against the inner wall of the guide groove 241. The frictional drive force applied by the operation of the lock lever 230 restricts the movement of the roll holding device 200. When the lock lever 230 is operated in reverse, the sliders 220 that are pressed against the inner wall of the guide groove 241 change to be separated from the inner wall of the guide groove 241. As a result of this operation of the lock lever 230, the frictional drive force is not applied, and the roll holding device 200 can be moved.

In other words, by operating the lock lever 230, the roll holding device 200 can change between a locked state where the movement of the rolled sheet 112 in the width direction W is restricted and an unlocked state where the movement of the rolled sheet 112 in the width direction W is not restricted. The lock lever 230 is disposed on the side face opposite to the side face on which the roll core holding mechanism 210 is attached. In other words, the lock lever 230 is disposed on the side opposite the side on which the rolled sheet 112 is held to prompt a user to operate the lock lever 230.

As illustrated in FIG. 5, each of the sliders 220 is a projection attached to the bottom face of the roll holding device 200. The sliders 220 are inserted into respective opening parts of the guide groove 241 in the guide rail 240 from the end of the guide groove 241 in the width direction W of the rolled sheet 112. Thus, the sliders 220 are movable in the width direction W. However, the sliders 220 contact the inner wall of the guide groove 241 to be restricted from moving in the direction perpendicular to the width direction W of the rolled sheet 112.

As illustrated in FIG. 1, the guide rail 240 is included in each of the sheet feeding device 102 and the sheet winding device 103. The respective guide rails 240 are disposed along the longitudinal direction of the hollow shaft 114 that is fixed to the sheet feeding device 102 and the hollow shaft 115 that is fixed to the sheet winding device 103. The guide rail 240 has the length longer than the width of the rolled sheet 112 and is disposed at a position to connect the bottom face of the sheet feeding device 102 and the bottom face of the sheet winding device 103.

When the rolled sheet 112 is to be fixed to the roll holding devices 200 disposed facing each other in the sheet feeding device 102, one of the roll holding devices 200 holds one end of the hollow shaft 114 that is the hollow portion of the rolled sheet 112. Thereafter, the other of the roll holding devices 200 is moved toward the opposite end of the hollow shaft 114 to hold the opposite end of the rolled sheet 112. Then, the lock lever 230 is moved to lock the roll holding device 200, thereby securing the position of the rolled sheet 112 in the width direction W. Since the roll holding device 200 is moved to secure the center of core of the rolled sheet 112, the center of core of the rolled sheet 112 can be secured and held at the predetermined position with such a simple operation.

Embodiment of Tension Adjuster

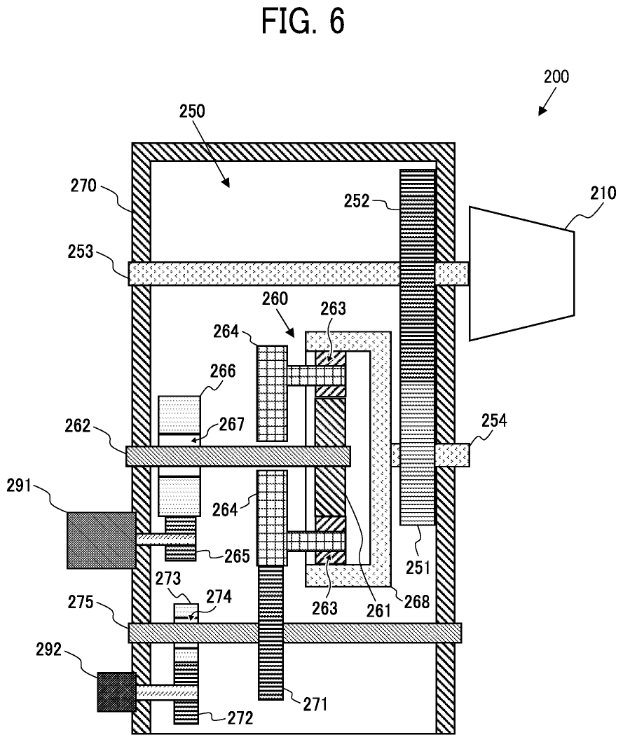

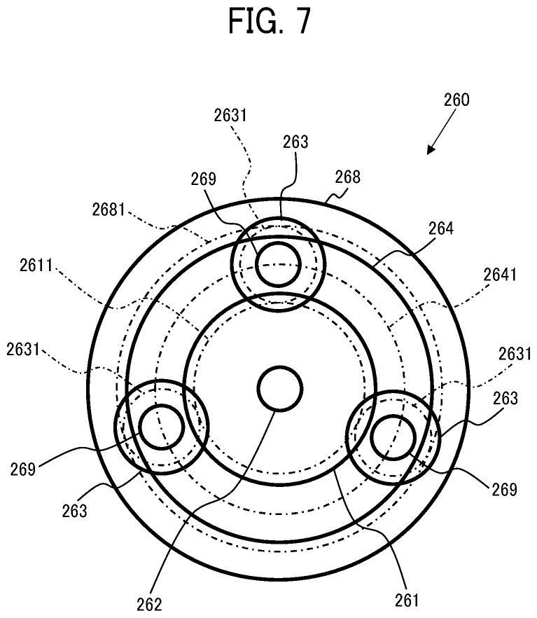

Now, a description is given of a drive transmission mechanism 250, with reference to FIGS. 6 and 7.

The drive transmission mechanism 250 serves as a tension adjuster according to the present disclosure and is included in the roll holding device 200.

FIG. 6 is a longitudinal cross-sectional side view of the roll holding device 200 including the roll core holding mechanism 210 and the drive transmission mechanism 250.

FIG. 7 is an axial projection view of a planetary gear mechanism 260 included in the drive transmission mechanism 250.

As illustrated in FIG. 6, the roll holding device 200 includes the roll core holding mechanism 210 for holding a roll medium, and the drive transmission mechanism 250 for transmitting the drive force to the roll core holding mechanism 210. The roll holding device 200 further includes a first drive source 291, a second drive source 292, and a frame 270. The first drive source 291 and the second drive source 292 drive the roll core holding mechanism 210 due to the operation of the drive transmission mechanism 250. The frame 270 holds the roll core holding mechanism 210, the first drive source 291, the second drive source 292, and the drive transmission mechanism 250. The respective torques and rotational drive forces of the first drive source 291 and the second drive source 292 are transmitted to the roll core holding mechanism 210 via the drive transmission mechanism 250.

The torque and rotational drive force of the drive transmission mechanism 250 are transmitted to a second output gear 252 via a first output gear 251. The second output gear 252 is fixedly mounted on a drive output shaft 253.

The drive output shaft 253 serving as a drive shaft has one end that is rotatably supported by the frame 270 and the opposite end that penetrates through one side plate of the frame 270 with the roll core holding mechanism 210 being fixed to the tip of the opposite end. The first output gear 251 is fixedly mounted on a first output shaft 254 that is coaxially disposed with the rotary shaft of an internal gear 268 described below.

In other words, as the internal gear 268 rotates, the first output gear 251 rotates together with the internal gear 268. Then, the second output gear 252 disposed to mesh with the first output gear 251 rotates, and the rotational drive force and torque from the internal gear 268 are transmitted to the roll core holding mechanism 210. By so doing, the roll core holding mechanism 210 rotates with respect to the frame 270.

As described below, the internal gear 268 rotates based on the rotational drive force from the two drive sources (i.e., the first drive source 291 and the second drive source 292) to transmit the rotational drive force to the drive shaft, thereby eventually rotating the rotary shaft of the roll core holding mechanism 210.

The drive transmission mechanism 250 is to transmit the torque and rotational drive force of the first drive source 291 and the second drive source 292 to the internal gear 268 by the planetary gear mechanism 260. The planetary gear mechanism 260 has the internal gear 268 that coaxially rotates with the first output gear 251 described above and is linked to the output side of the drive force. The planetary gear mechanism 260 includes a sun gear 261, a plurality of planetary gears 263, and a planetary gear carrier 264. The sun gear 261 is rotated by and coupled to the first drive source 291 coaxially with the internal gear 268. The plurality of planetary gears 263 are disposed between the internal gear 268 and the sun gear 261. The planetary gear carrier 264 serving as a planetary gear holder rotatably holds the plurality of planetary gears 263.

The torque or rotational drive force from the first drive source 291 is transmitted to the sun gear 261 via a first input gear 265 that is fixed to the rotary shaft of the first drive source 291, a second input gear 266 that is meshed with the first input gear 265, and a first torque limiter 267 that transmits the rotational drive force and torque of the second input gear 266 to a sun gear holding shaft 262 that is the rotary shaft of the sun gear 261.

The torque or rotational drive force from the second drive source 292 is transmitted to an external gear 271 via a third input gear 272 that is fixed to the rotary shaft of the second drive source 292, a fourth input gear 273 that is meshed with the third input gear 272, and a second torque limiter 274 that transmits the rotational drive force and torque of the fourth input gear 273 to an external gear rotary shaft 275 that is a rotary shaft of the external gear 271.

The external gear 271 transmits the rotational drive force and torque to the planetary gear carrier 264 that is rotated by and coupled to the second drive source 292. As a result, the torque or rotational drive force from the second drive source 292 is transmitted from the external gear 271 to the planetary gear carrier 264. The planetary gears 263 are rotatably held by a plurality of planetary gear holders 269 disposed on the planetary gear carrier 264. Since the planetary gears 263 mesh with the internal gear 268, the planetary gears 263 rotate on the internal gear 268 along with rotation of the planetary gear carrier 264.

In other words, the rotational drive force and torque from the first drive source 291 rotate the sun gear 261, so that the rotational drive force and torque are transmitted to the internal gear 268 via the planetary gears 263, then are transmitted to the output side of the drive transmission mechanism 250. The rotational drive force and torque from the second drive source 292 rotate the external gear 271 to rotate the planetary gear carrier 264, then the planetary gears 263 are meshed with and rotate on the internal gear 268, so that the rotational drive force and torque are transmitted to the internal gear 268. Then, the rotational drive force and torque are further transmitted to the output side of the drive transmission mechanism 250.

A description is given of the relation of the positions of the gears in the planetary gear mechanism 260 having the above-described configuration and the relations of the gear pitch circles of the gears.

As illustrated in FIG. 7, a planetary gear trajectory 2641 that corresponds to the trajectory of rotation of the planetary gear holders 269 on the planetary gear carrier 264 is located near a midpoint between an internal gear pitch circle 2681 and a sun gear pitch circle 2611. In other words, the internal gear pitch circle 2681 has a diameter greater than the diameter of the sun gear pitch circle 2611.

Due to such a configuration, a planetary gear pitch circle 2631 contacts the sun gear pitch circle 2611 and the internal gear pitch circle 2681. In other words, the rotational drive force and torque of the sun gear 261 that is driven in response to the input from the first drive source 291 and the rotational drive force and torque of the planetary gear carrier 264 that is driven in response to the input from the second drive source 292 are transmitted from the planetary gears 263 to the internal gear 268 based on the reduction ratio indicated by Equation (1) described below.

In Equation (1), the number of rotations of the sun gear 261 is represented by “Ns”, the number of rotations of the planetary gear carrier 264 is represented by “Nc”, the number of teeth of the sun gear 261 is represented by “Zs”, the number of teeth of the internal gear 268 is represented by “Zi”, the ratio of the number of teeth of the sun gear 261 and the number of teeth of the internal gear 268 is represented by “a”. In other words, “a” corresponds to “Zs/Zi”. The ratio of the number of rotations of the sun gear 261 and the number of rotations of the planetary gear carrier 264 is represented by “β”. In other words, “β” corresponds to “Ns/Nc”.

Based on the description above, the reduction ratio from the sun gear 261 to the internal gear 268 is expressed by the following equation, Equation (1).

Reduction Ratio=(1+β)/(α+β) Equation (1).

The symbol “α” represents the ratio of the number of teeth of the sun gear 261 and the number of teeth of the internal gear 268. As a result, the reduction ratio is a fixed value that is specified depending on the number of teeth of the sun gear 261 and the number of teeth of the internal gear 268.

The symbol “β” represents the ratio of the number of rotations of the sun gear 261 and the number of rotations of the planetary gear carrier 264. As described above, the rotational drive force is input to the sun gear 261 from the first drive source 291 via the first torque limiter 267. The rotational drive force of the second drive source 292 is input to the planetary gear carrier 264 via the second torque limiter 274. As a result, the symbol “β” representing the ratio of the number of rotations of the sun gear 261 and the number of rotations of the planetary gear carrier 264 is a variable value that can be varied by controlling the rotational speeds of the first drive source 291 and the second drive source 292.

Based on the description above, in the drive transmission mechanism 250 including the planetary gear mechanism 260, the damping ratio of the transmission torque from the sun gear 261 to the internal gear 268 can be adjusted by controlling such that the number of rotations of the first drive source 291 and the number of rotations of the second drive source 292 are at a predetermined ratio. In other words, as the rotational drive force from the sun gear 261 to the internal gear 268 and the rotational drive force from the planetary gear carrier 264 to the internal gear 268 are adjusted, the damping ratio of the rotational drive forces is set to a predetermined value. By so doing, the magnitude of the transmission torque to the first output shaft 254 is controlled. As a result, the magnitude of the transmission torque to the drive output shaft 253 can be controlled.

As described above, control over the number of rotations of two drive sources can adjust the torque applied to the roll core holding mechanism 210.

As described above with reference to FIG. 2, in the inkjet printer 100, as the sheet winding device 103 is rotated counterclockwise while the conveyance roller 23 and the pressure roller 24 hold the sheet 120, the sheet 120 is pulled toward the sheet winding device 103, so that given tension force is applied to the sheet 120. Due to this tension, the sheet winding device 103 stops rotation for winding the sheet 120 and the roll core holding mechanism 210 is locked. As the slip torque of the second torque limiter 274 is adjusted based on the reduction ratio of the planetary gear mechanism 260, the drive force of the second drive source 292 at the time of locking is transmitted to the roll core holding mechanism 210. As a result, application of tension to the sheet 120 is adjusted.

As described above, the drive transmission mechanism 250 serving as a tension adjuster applies tension to a roll medium. Since the planetary gears 263 of the planetary gear mechanism 260 included in the drive transmission mechanism 250 rotate in response to the inputs from two drive sources, the drive transmission mechanism 250 can control the reduction ratio. According to this configuration, since control of inputs of two drive sources can control the reduction ratio of the rotational drive force and torque to the output side, the drive torque to the rolled sheet 112 is varied. As a result, the tension applied to the sheet 120 can be varied.

In other words, while various known mechanisms employing frictional drive transmission has the configuration in size greater than the configuration of a typical drive transmission mechanism by securing a belt contact area and by additionally including a tension applying mechanism to obtain a drive torque, the drive transmission mechanism 250 according to the present embodiment can achieve a more compact configuration. In other words, the drive transmission mechanism 250 is provided with the planetary gear mechanism 260, which does not require to include a mechanism that transmits friction drive force. For this reason, the drive transmission mechanism 250 can vary the reduction ratio even with a compact mechanism.

The present disclosure is not limited to specific embodiments described above, and numerous additional modifications and variations are possible in light of the teachings within the technical scope of the appended claims. It is therefore to be understood that the disclosure of the present specification may be practiced otherwise by those skilled in the art than as specifically described herein. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A tension adjuster comprising:
a plurality of drive shafts;
a plurality of drive sources configured to rotate the plurality of drive shafts; and
a drive transmitter configured to transmit rotational drive force of the plurality of drive shafts to a rotary shaft of a conveyance object wound in a roll,
the drive transmitter including a planetary gear mechanism including a sun gear that is rotated by a first drive shaft of the plurality of drive shafts and a planetary gear carrier that is rotated by a second drive shaft of the plurality of drive shafts,
the planetary gear mechanism being configured to attenuate rotational drive force of one of the plurality of drive shafts to transmit the rotational drive force to the rotary shaft of the conveyance object,
the planetary gear mechanism being configured to transmit rotational drive force of the first drive shaft to the rotary shaft of the conveyance object, based on a damping ratio defined by a number of rotations of the sun gear and a number of rotations of the planet gear carrier.

2. The tension adjuster according to claim 1,
wherein the plurality of drive sources includes a first drive source and a second drive source,
wherein the planetary gear mechanism further includes:
a plurality of planetary gears meshing with the sun gear; and
an internal gear (internal gear 268) coupled to the plurality of planetary gears and the rotary shaft of the conveyance object, coaxially mounted with the sun gear, and having a pitch circle greater than a pitch circle of the sun gear,
wherein the sun gear is rotated by and coupled to the first drive source of the plurality of drive sources,
wherein the planetary gear carrier rotatably holds the plurality of planetary gears, and
wherein the planetary gear carrier is rotated by and coupled to the second drive source that is not rotated by or coupled to the sun gear and coaxially mounted with the sun gear.

3. A medium conveyor comprising:
a medium feeder configured to feed a conveyance object as a medium at a position upstream from a conveyor that conveys the conveyance object in a conveyance direction of the conveyance object; and
a medium winder configured to wind the conveyance object as a medium at a position downstream from the conveyor in the conveyance direction of the conveyance object,
at least one of the medium feeder or the medium winder including the tension adjuster according to claim 1.

4. An image forming apparatus comprising:
a recording head configured to form an image on a conveyance object with liquid discharged onto the conveyance object; and
the tension adjuster according to claim 1.
